(19) United States
(12) Patent Application Publication
(10) Pub. No.: US 2012/0259956 A1
(43) Pub. Date: Oct. 11, 2012

(54) SYSTEM AND METHOD FOR IMPLEMENTING A DYNAMIC CHANGE IN SERVER OPERATING CONDITION IN A SECURED SERVER NETWORK

(75) Inventor: Atul Dinkarpant JAWALKAR, Pune (IN)

(73) Assignee: INFOSYS TECHNOLOGIES, LTD., Bangalore (IN)

(21) Appl. No.: 13/220,833

(22) Filed: Aug. 30, 2011

(30) Foreign Application Priority Data
Apr. 7, 2011 (IN) 1208/CHE/2011

(51) Int. Cl. G06F 15/16

(52) U.S. Cl. 709/219

(57) ABSTRACT

A system and method of implementing a dynamic change in a server operating condition in a secured server network. A handling server receives a first request from a network device to access a specific service to be processed by a first application server. The handling server sends a first task to a first application server to process the first request, wherein the first task is stored and scheduled in a task processing queue of the first application server. The handling server receives a stand-by status command from the first application server indicating that it is going into a stand-by mode. The handling server does not send any new tasks to the first application server after receiving the stand-by status command. The handling server receives a first output result associated with the first task from the first application server, wherein the handling server sends the first output result to the network device.

This application claims the benefit of Indian Patent Application Filing No. 1208/CHE/2011, filed Apr. 7, 2011, which is hereby incorporated by reference in its entirety.

### FIELD

The present disclosure relates to a system and method for implementing a dynamic change in server operating condition in a secured server network.

### BACKGROUND

Many companies utilize software-based and web services-based business solutions to receive services from an enterprise resource solution. Current enterprise resource solutions comprise several servers within a secured server network in which one or more requested services are handled by one or more of the servers in the network. In many instances, a requested service may be shared and handled among several servers in the network.

One limitation with secured server networks which are configured to provide software-based or web services-based business solutions is the ability to quickly and effectively remove of one or more servers from the network. For instance, if a system administrator wants to conduct maintenance activity on a particular server, that server will need to be removed from a logon group. Additionally, the administrator would have to wait for all the users requesting services from that server to log off from the system. It is also possible that after the server is removed from the logon group, other processes can be requested of the off-line server from other servers in the secured network. This impacts the planned downtime window that the server can be down, especially when the server network is accessed continuously every day.

What is needed is a system and method implements a dynamic change in a server operating condition in a secured server network

### SUMMARY

In an aspect, a method of implementing a dynamic change in server operating condition in a secured server network. The method comprises operating a handling server in a secured server network that includes a plurality of application servers. The method includes receiving, at the handling server, a first request from a network device to access a specific service from the secured server network, wherein the specific service is to be processed by a first application server. The method includes sending a first task from the handling server to a first application server to process the first request, wherein the first task is stored and scheduled in a task processing queue of the first application server. The method includes receiving, at the handling server, a stand-by status command from the first application server which indicates that the first application server is going into a stand-by mode. The handling server does not send any new tasks to the first application server to process after receiving the stand-by status command. The method includes receiving a first output result associated with the first task from the first application server, wherein the handling server sends the first output result to the network device.

In an aspect, a non-transitory machine readable medium having stored thereon instructions for implementing a dynamic change in server operating condition in a secured server network. The medium comprising machine executable code which, when executed by at least one machine of a handling server, causes the machine to receive, at a handling server, a first request from a network device to access a specific service from the secured server network. The specific service is to be processed by a first application server. The code causes the machine to send a first task from the handling server to a first application server to process the first request, wherein the first task is stored and scheduled in a task processing queue by the first application server. The code causes the machine to receive, at the handling server, a stand-by status command from the first application server that indicates that the first application server is going into a stand-by mode. The handling server does not send any new tasks to the first application server to process after receiving the stand-by status command. The code causes the machine to receive a first output result associated with the first task from the first application server, wherein the handling server sends the first output result to the network device.

In an aspect, a computer system having a secured server network including a handling server and a plurality of application servers configured to implement a dynamic change in a server operating condition. The handling server comprises a server interface configured to allow communications with a handling server, a memory; and a processor coupled to the server interface and the memory. The processor is operative to receive, at a handling server, a first request from a network device to access a specific service from the secured server network, wherein the specific service is to be processed by a first application server. The processor is operative to send a first task from the handling server to a first application server to process the first request, wherein the first task is stored and scheduled in a task processing queue by the first application server. The processor is operative to receive, at the handling server, a stand-by status command from the first application server indicating that the first application server is going into a stand-by mode. The handling server does not send any new tasks to the first application server to process after receiving the stand-by status command. The processor is operative to receive a first output result associated with the first task from the first application server, wherein the handling server sends the first output result to the network device.

### BRIEF DESCRIPTION OF THE DRAWINGS

FIG. 1 is a diagram of an example system environment that implements and executes the novel system and method in accordance with an aspect of the present disclosure;

FIG. 2 illustrates a block diagram of one or more servers shown in FIG. 1;

FIG. 3 illustrates a block diagram of a plurality of servers in a secured server network in accordance with an aspect of the present disclosure;

FIG. 4 is an example flow chart diagram depicting portions of processes between one or more handling servers and one or more application servers in accordance with an aspect of the present disclosure; and

FIG. 5 is an example flow chart diagram depicting portions of processes between one or more handling servers and one or more application servers in accordance with an aspect of the present disclosure.

### DETAILED DESCRIPTION

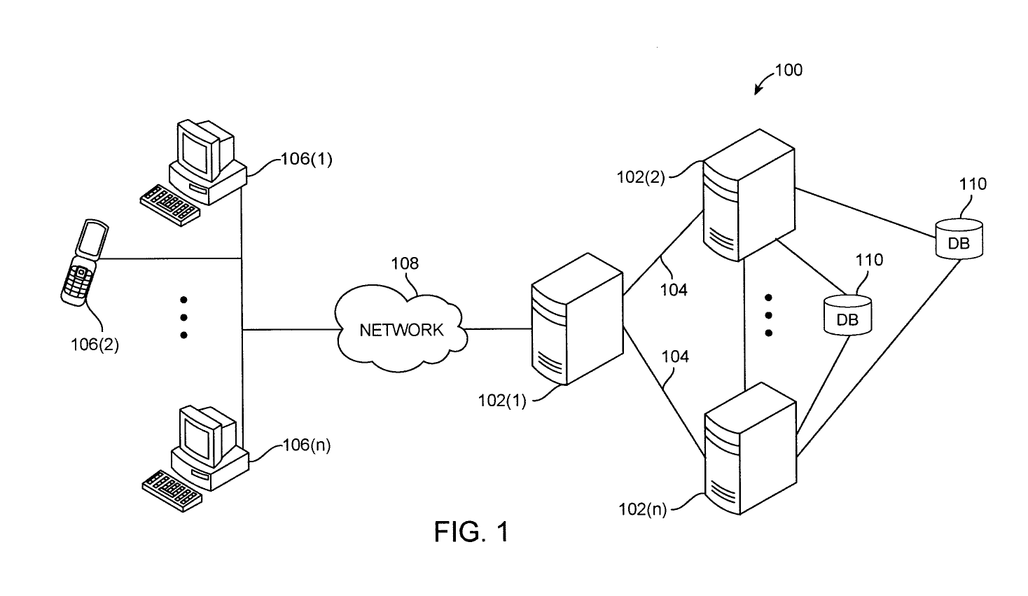

FIG. 1 is a diagram of an example system environment that implements and executes the novel system and method in accordance with an aspect of the present disclosure. As shown in FIG. 1, an example system environment 100 includes one or more servers 102 in a secured server network which includes at least one handling server 102(1) and one or more application servers 102(2)-102(n). The environment 100 includes one or more client devices 106(1)-106(n), although the environment 100 could include other numbers and types of devices in other arrangements. The servers 102 are connected to a local area network (LAN) 104 and the client devices 106 to a wide area network 108 in which the client devices 106 communicate with the servers 102 via the wide area network 108 and one or more LANs 104. It should be noted that although more than one client device 106 and server 102 are shown in FIG. 1, any number of client devices 106, including only one, as well as any number of servers 102, including only one, are contemplated. It should also be noted that although client device and/or server may be referred to in the plural within the specification, it is contemplated that only one client device and/or one server may be considered without being limiting to the language used herein. It should be understood that the devices and the particular configuration shown in FIG. 1 are provided for exemplary purposes only and thus are not limiting.

Client devices 106 comprise computing devices capable of connecting to other computing devices, such as the servers 102(1)-102(n). Such connections are performed over wired and/or wireless networks, such as network 108, to send and receive data, such as for Web-based and non Web-based requests, receiving responses to requests and/or performing other tasks, in accordance with the novel processes described herein. Non-limiting and non-exhausting examples of such devices include personal computers (e.g., desktops, laptops), mobile and/or smart phones, kiosks, personal tablets, PDAs and the like. In an example, client devices 106 may be configured to run a Web browser or dedicated software client program that provide a graphical user interface for operators, such as human users, to interact with for making requests for resources from one or more web based or non web based server applications via the network 108. It should be noted that it is contemplated that other server resources may be requested by the client devices 106. One or more requested applications may run on the server 102 that provide the requested data back to one or more exterior network devices, such as client devices 106.

Network 108 comprises a publicly accessible network, such as the Internet. However, it is contemplated that the network 108 may comprise other types of private and public networks that include other devices. Communications, such as requests from clients 106 and responses from servers 102, take place over the network 108 according to standard network protocols, such as the HTTP and TCP/IP protocols in this example. However, the principles discussed herein are not limited to this example and can include other protocols.

Further, it should be appreciated that network 108 may include local area networks (LANs), wide area networks (WANs), direct connections and any combination thereof, as well as other types and numbers of network types. On an interconnected set of LANs or other networks, including those based on differing architectures and protocols, routers, switches, hubs, gateways, bridges, and other intermediate network devices may act as links within and between LANs and other networks to enable messages and other data to be sent from and to network devices. Also, communication links within and between LANs and other networks typically include twisted wire pair (e.g., Ethernet), coaxial cable, analog telephone lines, mobile cell towers, full or fractional dedicated digital lines including T1, T2, T3, and T4, Integrated Services Digital Networks (ISDNs), Digital Subscriber Lines (DSLs), wireless links including satellite links and other communications links known to those skilled in the relevant arts. In essence, the network 108 includes any communication method by which data may travel between client devices 106(1)-106(n) and the servers 102(1)-102(n), and the like.

LAN 104 may comprise one or more private and public networks which provide secured access to the servers 102(1)-102(n). Networks, including local area networks, besides being understood by those skilled in the relevant arts, have already been generally described above in connection with network 108 and thus will not be described further.

Servers 102(1)-102(n) comprise one or more server computing machines capable of operating one or more Web-based or non Web-based applications that may be accessed by network devices (e.g. client devices, other servers) over the network 108. Such network devices include other servers as well as client devices 106(1)-106(n) which may provide other data representing requested resources, such as particular Web page(s), image(s) of physical objects, and any other objects, responsive to the requests. It should be noted that the servers 102(1)-102(n) may perform other tasks and provide other types of resources. It should be noted that one or more of the servers 102(1)-102(n) may be a cluster of servers managed by a network traffic management device, gateway device, router, hub and the like.

As per the TCP/IP protocols, requests from the requesting client devices 106 may be sent as one or more streams of data packets over network 108 to the servers 102(1)-102(n). Such protocols can establish connections, send and receive data for existing connections, and the like. It is to be understood that the one or more servers 102(1)-102(n) may be hardware and/or software, and/or may represent a system with multiple servers that may include internal or external networks. In this example, the servers 102(1)-102(n) may be any version of Microsoft® IIS servers, RADIUS servers and/or Apache® servers, servers running applications specific to SAP® applications, although other types of servers may be used. Further, additional servers may be coupled to the network 108 and many different types of applications may be available on servers coupled to the network 108.

Each of the servers 102(1)-102(n) and client devices 106(1)-106(n) may include one or more central processing units (CPUs), one or more computer readable media (i.e., memory), and interface systems that are coupled together by internal buses or other links as are generally known to those of ordinary skill in the art.

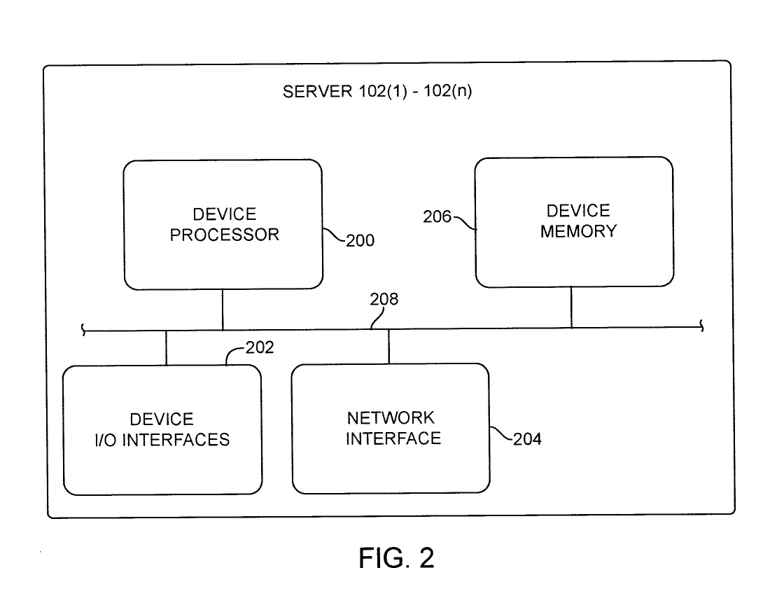

Referring now to FIG. 2, an example server 102 includes one or more device processors 200, one or more device I/O interfaces 202, one or more network interfaces 204 and one or more device memories 206, all of which are coupled together by one or more buses 208. It should be noted that the server 1026 could include other types and numbers of components.

Device processor 200 comprises one or more microprocessors configured to execute computer/machine readable and executable instructions stored in the device memory 206. Such instructions are implemented by the server 102 to perform the functions described below. It is understood that the processor 200 may comprise other types and/or combinations of processors, such as digital signal processors, micro-controllers, application specific integrated circuits (“ASICs”), programmable logic devices (“PLDs”), field programmable logic devices (“FPLDs”), field programmable gate arrays (“FPGAs”), and the like. The processor 200 is programmed or configured to execute the process in accordance with the teachings as described and illustrated herein with respect to novel method described below.

Device I/O interface 202 comprises one or more user input and output device interface mechanisms. The interface may include a computer keyboard, mouse, display device, and the corresponding physical ports and underlying supporting hardware and software to enable communication with other devices over the network 108. Such communications may include, but are not limited to, accepting user data input and providing output information to a user, programming and administering one or more functions to be executed by the corresponding device and the like.

Network interface 204 comprises one or more mechanisms that enable the server 102 to engage in TCP/IP communications with other network devices over LAN 104 and network 108. However, it is contemplated that the network interface 204 may be constructed for use with other communication protocols and types of networks. Network interface 204 is sometimes referred to as a transceiver, transceiving device, or network interface card (NIC), which transmits and receives network data packets to one or more networks, such as LAN 104 and network 108. In an example where the server 102 includes more than one device processor 200 (or a processor 200 has more than one core), each processor 200 (and/or core) may use the same single network interface 204 or a plurality of network interfaces 204. Further, the network interface 204 may include one or more physical ports, such as Ethernet ports, to couple its respective device with other network devices in the system 100. Moreover, the interface 204 may include certain physical ports dedicated to receiving and/or transmitting certain types of network data, such as device management related data for configuring the respective device.

Bus 208 may comprise one or more internal device component communication buses, links, bridges and supporting components, such as bus controllers and/or arbiters. The bus enable the various components of the device 102, such as the processor 200, device I/O interface 202, network interface 204, and the device memory 206, to communicate with one another. However, it is contemplated that the bus may enable one or more components of its respective device 102 to communicate with components in other devices as well. Example buses include HyperTransport, PCI, PCI Express, InfiniBand, USB, Firewire, Serial ATA (SATA), SCSI, IDE and AGP buses. However, it is contemplated that other types and numbers of buses may be used, whereby the particular types and arrangement of buses will depend on the particular configuration of the device 102 which houses the bus.

Device memory 206 of the server 102 comprises computer readable media, namely computer readable or processor readable storage media, which are examples of machine-readable storage media. Computer readable storage/machine-readable storage media may include volatile, nonvolatile, removable, and non-removable media implemented in any method or technology for storage of information. Such storage media contains computer readable/machine-executable instructions, data structures, program modules, or other data, which may be obtained and/or executed by one or more processors, such as device processor 200. Such instructions allow the processor to perform actions, including implementing an operating system for controlling the general operation of the server 102 to perform one or more portions of the novel process described below.

Examples of computer readable storage media include RAM, BIOS, ROM, EEPROM, flash/firmware memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information. Such desired information includes data and/or computer/machine-executable instructions and which can be accessed by a computing or specially programmed device 102.

Although an example of the server 102 is described and illustrated herein in connection with FIGS. 1 and 2, each of the computers of the system 100 could be implemented on any suitable computer system or computing device. It is to be understood that the example devices and systems of the system 100 are for exemplary purposes, as many variations of the specific hardware and software used to implement the system 100 are possible, as will be appreciated by those skilled in the relevant art(s). Furthermore, each of the devices of the system 100 may be conveniently implemented using one or more general purpose computer systems, microprocessors, digital signal processors, micro-controllers, application specific integrated circuits (ASIC), programmable logic devices (PLD), field programmable logic devices (FPLD), field programmable gate arrays (FPGA) and the like. The devices may be programmed according to the teachings as described and illustrated herein, as will be appreciated by those skilled in the computer, software, and networking arts.

In addition, two or more computing systems or devices may be substituted for any one of the devices in the system 100. Accordingly, principles and advantages of distributed processing, such as redundancy, replication, and the like, also can be implemented, as desired, to increase the robustness and performance of the devices and systems of the system 100. The system 100 may also be implemented on a computer system or systems that extend across any network environment using any suitable interface mechanisms and communications technologies including, for example telecommunications in any suitable form (e.g., voice, modem, and the like), Public Switched Telephone Network (PSTNs), Packet Data Networks (PDNs), the Internet, intranets, a combination thereof, and the like.

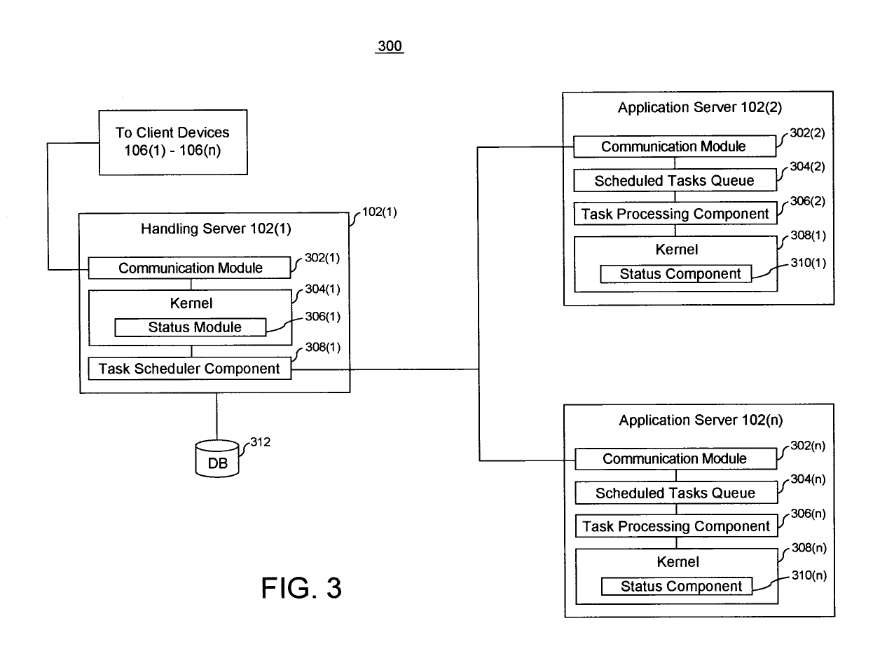

FIG. 3 illustrates a block diagram of a plurality of servers in the secured server network in accordance with an aspect of the present disclosure. As shown in FIG. 3, the secured server network 300 comprises at least one handling server 102(1) and one or more application servers 102(2)-102(n). In an aspect, the handling server 102(1) receives requests from one or more network devices to access one or more services from one or more of the application servers 102(2)-102(n) in the network 300 via a communication module 302(1). It should be noted that the requesting network devices may be one or more client devices 106(1)-106(n) and/or one or more application servers 102(2)-102(n) located in the network 300.

In an aspect, the requests received by the handling server 102(1) are for general services which may be handled by any or all of the application servers 102(2)-102(n) or may be for specific services which can only be handled by one or more specific application servers. The handling server 102(1) uses network optimization or other techniques (e.g. load balancing, server specific requests and the like) to assign tasks associated with the requested services to one or more application servers 102(2)-102(n) by use of a task scheduler component 308(1). The entire task or portions of the task that are assigned to the application servers 102(2)-102(n) are communicated to the appropriate application servers 102(2)-102(n) via the communication module 302(1) and stored in a database memory 312.

The handling server 102(1) includes an operating system which is represented in a kernel layer 304(1) which allows the handling server 102(1) to process instructions and handling all processing and communication tasks. In an aspect, the kernel layer 304(1) includes a status module 306(1) which provides the handling server 102(1) with information regarding the operation status of all the application servers 102(2)-102(n) in the secured network 300. In an example, if an application server were to go off-line and thus be inaccessible, this information will be kept in the status module, whereby the handling server 102(1) will not send any new tasks to the application server which indicates that it is offline.

The application servers 102(2)-102(n) shown in FIG. 3 receive tasks from the handling server 102(1) via a communication module 302(1)-302(n). In an aspect, the tasks are associated with one or more requested service that the application servers 102(2)-102(n) are to process and provide a result output. It should be noted that the requested services that are sent from the handling server 102(1) may actually be from one or more client devices 106(1)-106(n) and/or one or more application servers 102(2)-102(n) in the network 300. In an aspect, the tasks that are scheduled to be processed by the application servers 102(2)-102(n) may be for general services or specific services which can only be handled by that particular application server.

The tasks, once received, are placed in a scheduling queue 304(2)-304(n) in accordance with known techniques and are processed by a task processing component 306(2)-306(n). The output results for the tasks are then sent via the communication module 302(2)-302(n) back to the handling server 102(1) for handling.

The applications servers 102(2)-102(n) utilize an operating system which is represented in a kernel layer 304(2)-304(n) which allows the application servers 102(2)-102(n) to process instructions and handling all processing and communication tasks. In an aspect, the kernel layer 304(2)-304(n) includes a status module 306(2)-306(n) which communicates the mode in which the application server 102(2)-102(n) is currently running. In an example, application server 102(2) may send a status command to the handling server 102(1) indicating that the application server 102(2) will be going into a stand-by mode. The handling server 102(1), upon receiving the stand-by status command, will update and store the operating mode of application server 102(2) in its status module 304(1) and not send any new tasks to the application server 102(1) while that application server 102(2) is in the stand-by mode. However, as will be discussed below, the application server 102(2) will continue to process all scheduled tasks that are remaining in its task processing component 306(2) and output the results to the handling server 102(1). Once all remaining scheduled tasks are completed and output, the application server 102(2) will be able to undergo maintenance operations or other operations while remaining on-line within the secured server network 300.

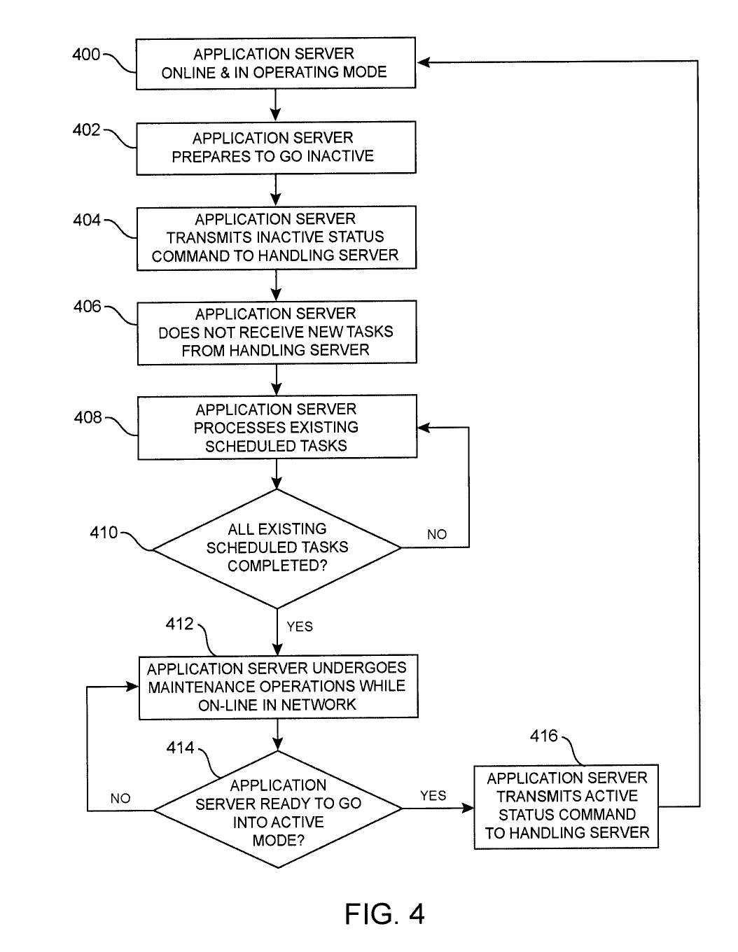

FIG. 4 illustrates an example flow chart diagram depicting portions of processes between one or more application servers and one or more handling servers in accordance with an aspect of the present disclosure. As shown in FIG. 4, the process begins with one or more application servers, in this example application server 102(2), being online in the network 300 and functioning in an operating mode (Block 400). As stated above, while in the operating mode, the application server 102(2) receives ongoing tasks from the handling server 102(1) which are scheduled and processed by the application server 102(2), whereby the application server 102(2) outputs results for each scheduled task to the handling server 102(1).

The application server 102(2) at some point in the process may need to perform maintenance or other operations which are not related to the processing and handling of tasks, whereby a network administrator or other individual will prepare the application server 102(2) to go inactive or into a stand-by operational mode (Block 402). The application server 102(2) will then transmit a status command to the handling server 102(1) indicating that the application server 102(2) operational mode is to change from an active mode to a stand-by (or other equivalent) mode (Block 404).

Once the handling server 102(1) receives the status command from the application server 102(2), the handling server 102(1) terminates sending any new tasks to the application server 102(2) (Block 406). The application server 102(2), however, continues to process all tasks which are already scheduled in its task processing component (Block 408). This process repeats until the application server 102(2) has completed all the scheduled tasks and has output the results associated with each of the already scheduled tasks to the handling server (Block 410). Once all of the results are outputted and no scheduled tasks remain in the task processing component, the application server 102(2) is able to undergo the administrative operations (e.g. maintenance, diagnostics, repair) while it remains on-line (or off-line) in the secured server network (Blocks 412 and 414). Once the application server 102(2) is ready to go back on line, the administrator can configure the application server 102(2) to send an active status command to the handling server 102(1) which indicates a change in its operational mode from stand-by to active (Block 416). The application server 102(2) will then be active, on-line and able to receive and process new tasks (Block 400).

In an aspect, if the application server 102(2) is rebooted, the application server 102(2) can be configured such that it will not send an automatic status command to the handling server 102(1) indicating that it is again in the active mode. In this example, the application server 102(2) will send an active status command to the handling server 102(1) only when the administrator manually instructs the application server 102(2) to send an update status command indicating that the application server 102(2) is operating in the active mode.

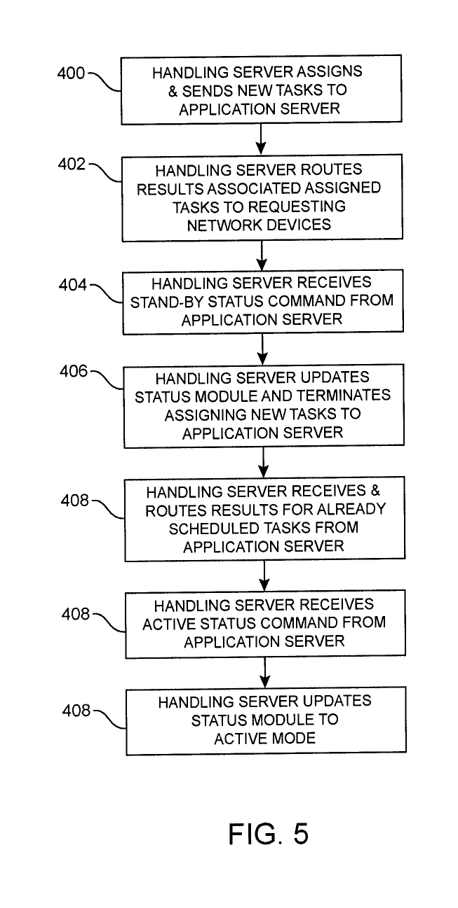

FIG. 5 illustrates an example flow chart diagram depicting portions of processes between one or more application servers and one or more handling servers in accordance with an aspect of the present disclosure. As shown in FIG. 5, the process begins with one or more handling servers, in this example handling server 102(1), assigning and sending new tasks to an application server that is in active mode, in this example application server 102(2), whereby the new tasks are associated with new requests from one or more network devices operating mode (Block 500). As stated above, while in the operating mode, the application server 102(2) receives ongoing tasks from the handling server 102(1) which are scheduled and processed by the application server 102(2), whereby the application server 102(2) outputs results for each scheduled task to the handling server 102(1).

The handling server 102(1) routes the output results to the appropriate requesting network devices (Block 502). As stated above in FIG. 4, the application server 102(2) may need to go into stand-by mode where it cannot handle new tasks, whereby it will transmit a status command to the handling server 102(1) indicating that the operating mode of the application server 102(2) mode is to change from an active mode to a stand-by (or other equivalent) mode. The stand-by status command is then received by the handling server 102(1) (Block 504).

The handling server 102(1), upon receiving the stand-by status command, updates its status module 306(1) and terminates sending any new tasks to the application server 102(2) (Block 506). However, the handling server 102(1) continues to receive results from the application server 102(2) for tasks that are already scheduled in the application server's 102(2) task processing component. The handling server 102(1) handles and routes these results to the appropriate network devices (Block 508) while the application server 102(2) undergoes administrative operations while on-line or off-line with respect to the secured server network.

This process continues until the handling server 102(1) receives a status command from the application server 102(1) indicating that the application server 102(2) is in active mode and is able to receive and process new tasks (Block 510). Upon receiving the active status command, the handling server 102(1) updates the status module 306(1) (Block 512) and resumes assigning and sending new tasks to the application server 102(2) (Block 500).

Once the handling server 102(1) receives the status command from the application server 102(2), the handling server 102(1) terminates sending any new tasks to the application server 102(2) (Block 406). The application server 102(2), however, continues to process all tasks which are already scheduled in its task processing component (Block 408). This process repeats until the application server 102(2) has completed all the scheduled tasks and has output the results associated with each of the already scheduled tasks to the handling server (Block 410). Once all of the results are outputted and no scheduled tasks remain in the task processing component, the application server 102(2) is able to undergo the administrative operations (e.g. maintenance, diagnostics, repair) while it remains on-line (or off-line) in the secured server network (Blocks 412 and 414).

Once the application server 102(2) is ready to go back on line, the administrator can configure the application server 102(2) to send an active status command to the handling server 102(1) which indicates a change in its operational mode from stand-by to active (Block 416). The application server 102(2) will then be active, on-line and able to receive and process new tasks (Block 400).

While embodiments and applications have been shown and described, it would be apparent to those skilled in the art having the benefit of this disclosure that many more modifications than mentioned above are possible without departing from the inventive concepts disclosed herein. The invention, therefore, is not to be restricted except in the spirit of the appended claims.

What is claimed is:

1. A method of implementing a dynamic change in server operating condition in a secured server network, the method comprising:
operating a handling server in a secured server network including a plurality of application servers;
receiving, at the handling server, a first request from a network device to access a specific service from the secured server network, wherein the specific service is to be processed by a first application server;
sending a first task from the handling server to a first application server to process the first request, wherein the first task is stored and scheduled in a task processing queue by the first application server;
receiving, at the handling server, a stand-by status command from the first application server indicating that the first application server is going into a stand-by mode, wherein the handling server does not send any new tasks to the first application server to process after receiving the stand-by status command;
receiving a first output result associated with the first task from the first application server, wherein the handling server sends the first output result to the network device.

2. The method of claim 1 further comprising:
receiving, at the handling server, a second request from at least one network device to access a service from the secured network, wherein the second request is received prior to the handling server receiving the stand-by status command from the first application server;
assigning, at the handling server, a second task associated with the second request to the first application server;
receiving, at the handling server, a second output result associated with the second task from the first application server;
sending the second output result to the corresponding at least one network device.

3. The method of claim 1 further comprising:
receiving, at a handling server, a second request from at least one network device to access a service from the secured network, wherein the second request is received after the handling server receives the stand-by status command from the first application server;
assigning, at a handling server, a second task associated with the second request to a second application server;
receiving, at a handling server, a second output result associated with the second task from the second application server;
sending the second output result to the corresponding at least one network device.

4. The method of claim 1 further comprising receiving, at the handling server, an operating status command from the first application server indicating that the first application server's status changed from the stand-by mode to the operating mode.

5. The method of claim 4, further comprising scheduling new tasks to be processed by the application server upon receiving the operating status command at the handling server.

6. The method of claim 1, wherein at least one of the network devices is a client device.

7. The method of claim 1, wherein at least one of the network devices is another application server in the secured server network.

8. A non-transitory machine readable medium having stored thereon instructions for implementing a dynamic change in server operating condition in a secured server network, comprising machine executable code which when executed by at least one machine of a handling server, causes the machine to:
receive, at a handling server, a first request from a network device to access a specific service from the secured server network, wherein the specific service is to be processed by a first application server;
send a first task from the handling server to a first application server to process the first request, wherein the first task is stored and scheduled in a task processing queue by the first application server;
receive, at the handling server, a stand-by status command from the first application server indicating that the first application server is going into a stand-by mode, wherein the handling server does not send any new tasks to the first application server to process after receiving the stand-by status command;
receive a first output result associated with the first task from the first application server, wherein the handling server sends the first output result to the network device.

9. The machine readable medium of claim 7 wherein the machine is configured to:
receive a second request from at least one network device to access a service from the secured network, wherein the second request is received prior to the handling server receiving the stand-by status command from the first application server;
assign a second task associated with the second request to the first application server;
receive a second output result associated with the second task from the first application server;
send the second output result to the corresponding at least one network device.

10. The machine readable medium of claim 7 wherein the machine is configured to:
receive a second request from at least one network device to access a service from the secured network, wherein the second request is received after the handling server receives the stand-by status command from the first application server;
assign a second task associated with the second request to a second application server;
receive a second output result associated with the second task from the second application server;
send the second output result to the corresponding at least one network device.

11. The machine readable medium of claim 7 wherein the machine is configured to receive an operating status command from the first application server indicating that the first application server's status changed from the stand-by mode to the operating mode.

12. The machine readable medium of claim 11, wherein the machine is configured to schedule new tasks to be processed by the application server upon receiving the operating status command.

13. The machine readable medium of claim 7, wherein at least one of the network devices is a client device.

14. The machine readable medium of claim 7, wherein at least one of the network devices is another application server in the secured server network.

15. A computer system having a secured server network including a handling server and a plurality of application servers configured to implement a dynamic change in server operating condition, the handling server comprising:
a server interface configured to allow communications with a handling server;
a memory;
a processor coupled to the server interface and the memory, the processor operative to:
receive, at a handling server, a first request from a network device to access a specific service from the secured server network, wherein the specific service is to be processed by a first application server;
send a first task from the handling server to a first application server to process the first request, wherein the first task is stored and scheduled in a task processing queue by the first application server;
receive, at the handling server, a stand-by status command from the first application server indicating that the first application server is going into a stand-by mode, wherein the handling server does not send any new tasks to the first application server to process after receiving the stand-by status command;
receive a first output result associated with the first task from the first application server, wherein the handling server sends the first output result to the network device.

16. The computer system of claim 15 wherein the handling server is configured to:
receive a second request from at least one network device to access a service from the secured network, wherein the second request is received prior to the handling server receiving the stand-by status command from the first application server;
assign a second task associated with the second request to the first application server;
receive a second output result associated with the second task from the first application server;
send the second output result to the corresponding at least one network device.

17. The computer system of claim 15 wherein the handling server is configured to:
receive a second request from at least one network device to access a service from the secured network, wherein the second request is received after the handling server receives the stand-by status command from the first application server;
assign a second task associated with the second request to a second application server;
receive a second output result associated with the second task from the second application server;
send the second output result to the corresponding at least one network device.

18. The computer system of claim 17 wherein the handling server is configured to receive an operating status command from the first application server indicating that the first application server's status changed from the stand-by mode to the operating mode.

19. The computer system of claim 15 wherein the handling server is configured to schedule new tasks to be processed by the application server upon receiving the operating status command.

20. The computer system of claim 15 wherein at least one of the network devices is a client device.

21. The computer system of claim 15 wherein at least one of the network devices is another application server in the secured server network.
